(19) United States
(12) Patent Application Publication
(10) Pub. No.: US 2009/0167208 A1
(43) Pub. Date: Jul. 2, 2009

(54) METHOD FOR SUPPLYING A DC LOAD VIA MULTIPLE PARALLEL POWER SUPPLIES AND A POWER SUPPLY THEREFOR

(75) Inventor: Victor DOROSHEV, Ramla (IL)

Correspondence Address: OLIFF & BERRIDGE, PLC, P.O. BOX 320850, ALEXANDRIA, VA, 22320-4850, US

(73) Assignee: LIGHTECH ELECTRONIC INDUSTRIES LTD., Lod (IL)

(21) Appl. No.: 12/346,033

(22) Filed: Dec. 30, 2008

(30) Foreign Application Priority Data
Dec. 30, 2007 (IL) 188497

(51) Int. Cl. H05B 37/02

(52) U.S. Cl. 315/294

(57) ABSTRACT

The present invention relates to a lamp illumination system and method for sharing power to an electrical DC load that exceeds a capacity of a first DC power supply between the first DC power supply and a second DC power supply such that in combination all of the power supplies are able to provide rated load power, said method comprising: connecting across the load the first and second DC power supplies each having a respective partial series resonance converter that produces during alternate switching cycles an output voltage across respective resonance capacitors thereof and each converter being operable in clamping mode; and operating the converter of the first DC power supply in clamping mode so as to limit an output voltage across the respective resonance capacitors thereof and thereby prevent the first DC power supply from attempting to source a load that exceeds a nominal power rating of the first DC power supply within a predetermined accuracy, whereby any power shortfall to the load is provided by the second DC power supply.

### CROSS REFERENCE TO RELATED APPLICATIONS

This application claims the benefit of Israeli Patent Application Number 188497 filed on Dec. 30, 2007, which is hereby incorporated by reference herein.

### FIELD OF THE INVENTION

This invention relates to power supplies.

### BACKGROUND OF THE INVENTION

In many applications it is desirable to connect multiple DC power supplies in parallel. This may be done to increase the total current available or for redundancy. One particular application with which the present invention relates to is the powering of low voltage tungsten halogen or xenon lamps via a low voltage DC supply. To this end, it is known to fix a DC supply rail comprising positive and negative DC supply lines to or near the ceiling and then to mount one or more lamps to the supply rail across the supply lines. Commonly, the lamps can be moved along the supply rail so as to allow them to be directed in a preferred location.

In such a configuration, the number of lamps of any given power rating that be can be connected to the supply rail is limited by the power rating of the supply. This means that once the maximum power rating of the supply is exceeded, additional lamps can be connected to the supply rail only by coupling one or more additional power supplies to the supply rail. In practice this is fraught with difficulties.

FIG. 1 shows one approach based on the Unitrode UC3907 controller, where across the output of each power supply a resistor serves as a current sensor that is sensed by a respective controller. All the controllers are commonly connected both to the DC power lines and also via control lines to the load, thus requiring four wires to be routed between each power supply instead of the two (positive and negative) power lines usually required. This feature must be designed into the power supply. All the supplies are linked together so that a change in output current in one supply is compensated for by the other supplies. The result is the total load current is evenly split among the supplies.

Another known approach to power sharing and disclosed in US 2005/083640 to Weidmüller seeks to have the total load current split evenly among the supplies in parallel. For example, if four supplies are used to deliver 20 A they seek to have each supply loaded to 5 A in order that each supply will be operating properly. If a supply is required to go from no load to full load instantaneously (which is the case when a supply delivering almost all of the load current fails), it may go into current limiting. Proper load sharing also means the operating life will be maximized (the MTBF is longer at 80% of full load than at 100%).

Proper load sharing can only be accomplished when the output voltage of the supplies are at the same level at the point where they are commoned. This means that voltage drop in the wiring must also be taken into account. For example, if the terminals of one supply are used as the common point (i.e. two supplies are connected in parallel by daisy-chaining the output terminals and the load is connected directly to the terminals of one supply), then the voltage drop in the wires between the two supplies may affect the load sharing. An imbalance of as little as 50-75 mV can lead to the supply with the highest output voltage delivering virtually all the load current. If the output current rating is not sufficient for such a load current, the power supply will shutdown because of over-current or over-temperature. Maintaining a zero imbalance condition is very difficult—temperature fluctuation, component tolerances, and power supply location (i.e. wire lengths) are some of the factors that can influence the output voltage.

Often in applications involving parallel power supplies diodes are used to prevent a supply with a low output voltage from drawing current from a supply with a higher output voltage. This approach does not improve the load sharing situation and also introduces a voltage drop as well as additional heat dissipation. For example, a typical diode with a 0.7V drop used with a 10 A power supply would have to be rated for 7 W of power dissipation. This means a heat sink is required and the heat dissipation may affect other devices in the control circuitry. Schottky diodes offer a lower voltage drop and thus less heat dissipation, but still do not eliminate the problems.

To overcome these problems, Weidmüller proposes two solutions: (i) diode modules with pre-calibration of power supplies to ±50 millivolt and (ii) load sharing similar to the Unitrode design shown in FIG. 1.

In the first approach, the diode modules enable multiple power supplies connected in parallel to adjust their outputs to maintain zero current imbalance. It is apparent that such an approach requires additional circuitry in each power supply and this adds to the expense and the bulk of the power supply, to such an extent that the power supply becomes both prohibitively expensive and bulky for low voltage lamp applications. It should be borne in mind that low voltage lamps do not need constant DC for their proper operation and this facilitates the use of low cost power supplies. Hence, the solution proposed by Weidmüller is hardly practical for such applications.

Even apart from this, such a solution requires pre-calibration of the power supplies to with ±50 mV and preferably requires that the parallel connection be effected as close as possible to the load, thus effectively militating against distributed loads along the complete span of the supply rail. In most lamp rail or track applications it is usually more convenient to connect multiple power supplies at different locations across the supply rail, for example at opposite ends.

DC power supplies that are designed to operate from the mains AC power supply include a diode bridge rectifier. Consequently, the connection of multiple DC supplies in parallel is equivalent to the circuit described above.

FIG. 2 shows a prior art series resonant converter 10 described on page 20 of “Electronic DC Transformer with High Power Density” by Martin Pavlosky. The converter 10 comprises an input source Vᵢₙ of high voltage DC coupled across a pair of anti-phase fast acting switches S₁ and S₂ that chop the DC voltage to produce quasi-AC in known manner. Respective diodes are connected across the switches in order that each switch is turned on when its anti-parallel diode conducts. Snubber capacitors C₁ and C₂ are connected across the switches S₁ and S₂ and serve to reduce the turn-off loss of the respective switches by reducing the voltage rise during the turn-off interval. The resulting voltage pulses are stepped-down by a transformer TR, so as to produce at a secondary thereof low voltage AC that is rectified prior to feeding a low voltage DC load. Respective resonant capacitors Cᵣ₁ and Cᵣ₂ are connected across the switches and operate as de-link capacitors which serve as a voltage divider for the half-bridge inverter. The resonance frequency is defined by the resonant capacitors Cᵣ₁ and Cᵣ₂ in conjunction with the leakage inductance Lₛ and Lₚ of the transformer TR. Clamping diodes Dᵣ₁ and Dᵣ₂ are connected across the resonant capacitors Cᵣ₁ and Cᵣ₂ and serve to clamp the output voltage of the series resonance converter by preventing the build up of negative voltage across the resonant capacitors.

The full resonance converter shown in FIG. 2 has a near optimal switching current waveform shown in FIG. 3 that approaches the ideal waveform. As noted by Pavlosky, the proposed waveform has influence on turn-on, turn-off and conduction loss, and can be optimized to minimize the total loss. The current waveform of a full resonance converter consists of three main intervals, During Interval I, zero-voltage switching conditions are maintained for the turn-on of the switches by antiparallel diodes across the switches conducting. Interval II includes current rise and also current reduction. The current shape is the result of the resonance. Interval III is the turn-off interval where the switches are turned off with reduced current (quasi-zero-current-crossing) and a voltage that is reduced by the snubber capacitors C₁ and C₂.

Conventional full resonance converters do not lend themselves to parallel connection for the reasons described above. Specifically, the peak voltage across each of the resonant capacitors C₃ and C₄ is not limited. As the load increases the effective resistance of the voltage transformer decreases and this can lead to capacitors C₃ and C₄ to a state of over-voltage, whose magnitude is a function of:

$$\frac{\sqrt{\frac{{L}_{s}}{{C}_{3} + {C}_{4}}}}{{R}_{Load}}$$

This means that there is no effective limit to the load sourced by one of the resonant capacitors since if the resulting capacitor voltage increases beyond the peak supply voltage, the voltage across the other resonant capacitor will simply go negative, so that the sum of the capacitor voltages remains equal to the peak input voltage. Consequently, if two such converters are connected in parallel across a load that is actually larger than the power rating of one of the converters, there is no intrinsic mechanism to stop one converter from attempting to supply the full load. Of course, over-current and temperature protection may, and typically will, be provided but this merely stops the converter from working altogether and then the same problem is repeated in respect of the second converter, with the end result that all the converters will be shut down and no power will be applied to the load at all.

FIG. 4 shows a circuit that is similar to converter shown in FIG. 2 but that has the clamping diodes and operates as a partial series resonance converter. In this case, the above-mentioned problem will not occur because the clamping diodes prevent the voltage across the respective resonant capacitors from going negative. So, the peak voltage across any one of the resonant capacitors can never be higher than √2*Vᵢₙ. However, the circuit is configured to operate only as a partial series resonance converter having a non-optimum current waveform shown in FIG. 5.

Pavlosky devotes much space to a comparison of the circuits reproduced in FIGS. 2 and 4 and the reader is referred to the full article for a complete discussion. For our purposes, it suffices to note his conclusion that for operation at high power levels, partial series resonance converter (PSRC) topology is unfavorable because it exists only as a half-bridge topology. This implies double current rating for the semiconductor switches in comparison with the full-bridge configuration which is available for full resonance converter (FRC) topology.

Pavlosky also devotes much space to use of the converters shown in FIGS. 2 and 4 at high power levels and notes that in principle, a system for increased power level could be obtained by using multiple converter modules. Such an approach uses multiple identical converter modules where each unit processes a portion of the total power. The input and output voltage levels of the units determine the input and output voltage of the complete system. These voltages can be modified by series and parallel connection of inputs and outputs of the units. He notes that in practical implementations, the total power density depends also on the level of the spatial integration of the units and on the volume of the required supporting infrastructure. To prevent overloading, special attention must be paid to power-sharing between the converter modules. Also, the heat removal from each converter module must be considered to prevent overheating. In principle, the number of units in a system is unlimited. In practical applications, the limitation is posed by the complexity of the resulting system. He concludes that the converter circuits shown in FIGS. 2 and 4 should be able to work in a multi-unit configuration but it is clear that this is at the expense of additional control circuitry to compensate for the spatial separation between different converters connected to the output supply rail.

It would clearly be desirable to provide a method and circuit that allows multiple converters to be connected in a power sharing arrangement without being prone to these drawbacks.

### SUMMARY OF THE INVENTION

According to an aspect of the invention, there is provided a method for sharing power to an electrical DC load that exceeds a capacity of a first DC power supply between the first DC power supply and a second DC power supply such that in combination all of the power supplies are able to provide rated load power, said method comprising:
(a) connecting across the load the first and second DC power supplies each having a respective partial series resonance converter that produces during alternate switching cycles an output voltage across respective resonance capacitors thereof and each converter being operable in clamping mode; and
(b) operating the converter of the first DC power supply in clamping mode so as to limit an output voltage across the respective resonance capacitors thereof and thereby prevent the first DC power supply from attempting to source a load that exceeds a nominal power rating of the first DC power supply within a predetermined accuracy, whereby any power shortfall to the load is provided by the second DC power supply.

According to another aspect of the invention, there is provided a lamp illumination system comprising:

a pair of DC supply rails configured for connecting multiple lamps thereto; and

at least two spatially distributed power supplies connected to the DC supply rails, each of the power supplies comprising a partial resonance converter being operable in clamping mode so as to prevent the respective power supply from attempting to source a load that exceeds a nominal power rating of the power supply within a predetermined accuracy.

### BRIEF DESCRIPTION OF THE DRAWINGS

In order to understand the invention and to see how it may be carried out in practice, some embodiments will now be described, by way of non-limiting example only, with reference to the accompanying drawings, in which:

FIG. 1 is a schematic circuit diagram of a prior art circuit for connecting multiple power supplies in parallel;

FIG. 2 is a schematic circuit diagram of a prior art full resonance converter;

FIG. 3 is a near optimal switching current waveform achieved by the full resonance converter of FIG. 2;

FIG. 4 is a schematic circuit diagram of a prior art partial resonance converter;

FIG. 5 is a non-optimal switching current waveform achieved by the partial resonance converter of FIG. 4;

FIG. 6 is a schematic circuit diagram of a modified partial resonance converter having a clamped output according to the invention;

FIG. 7 shows schematically a lamp illumination system fed by two spatially distributed power supplies according to the invention;

FIG. 8 shows graphically power output-load characteristics of a current source, voltage source and the converter shown in FIG. 6; and

FIG. 9 shows graphically load-frequency characteristics of the converter shown in FIG. 6.

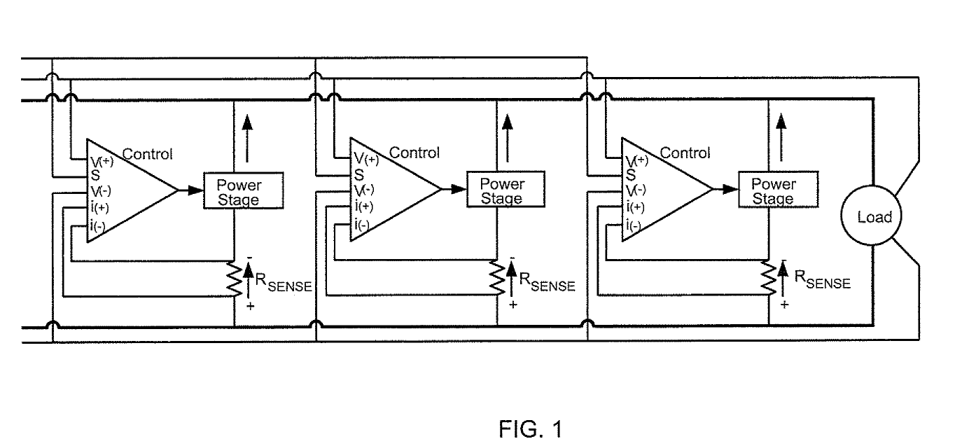

### DETAILED DESCRIPTION OF EMBODIMENTS

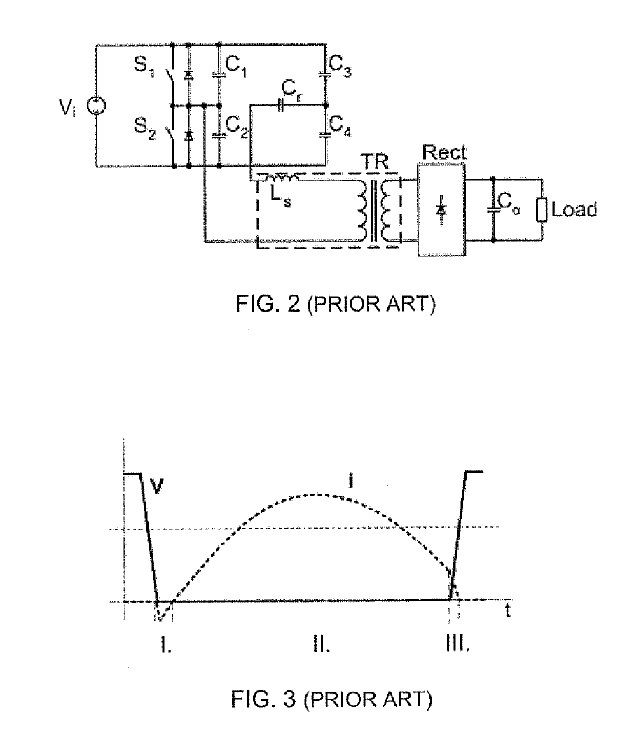

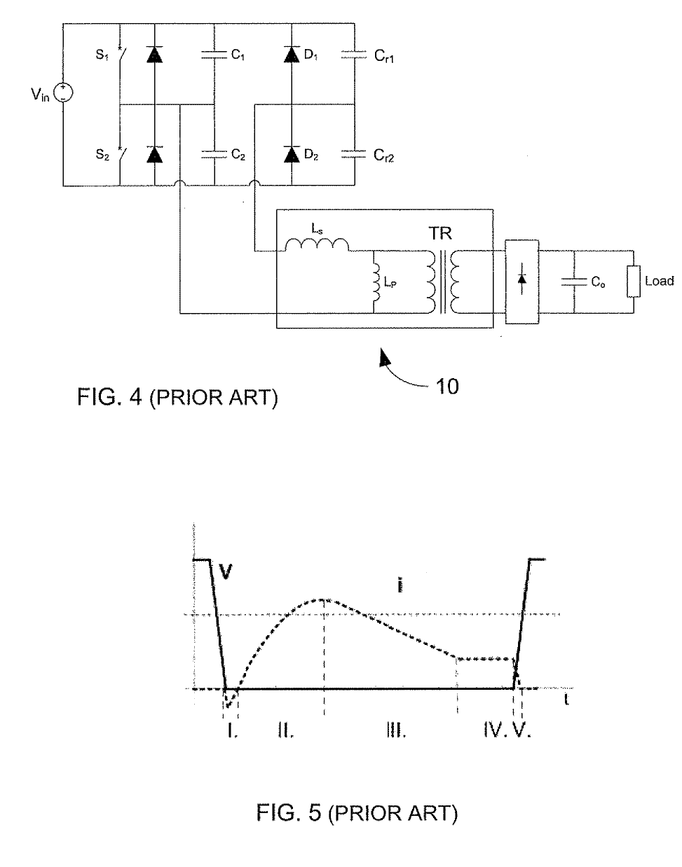

In the following description, components that are identical to those already described with reference to FIGS. 2 and 4 or serve the same function will be identified by the same symbols or reference numerals.

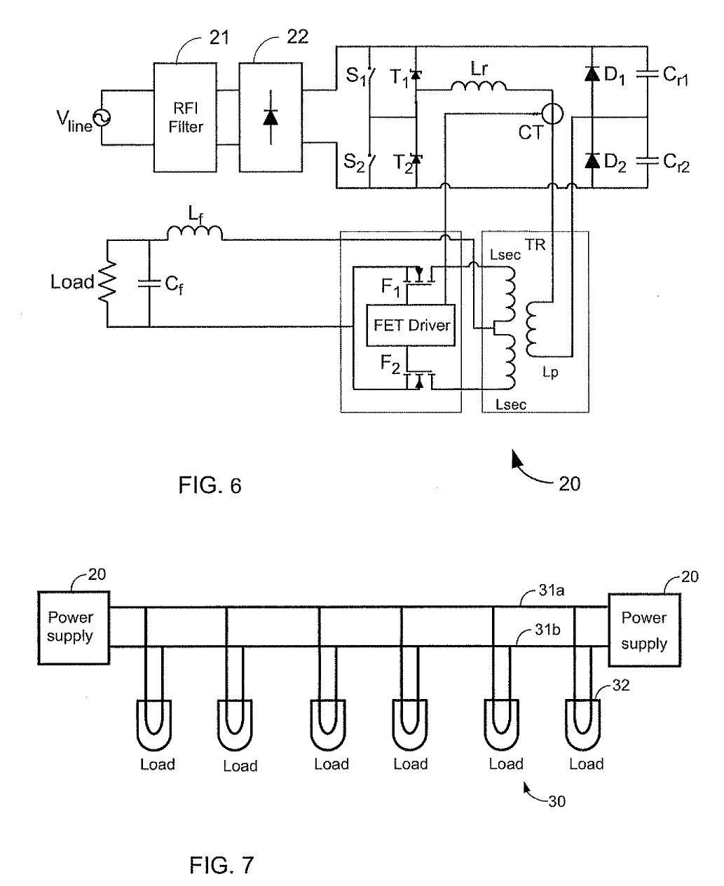

FIG. 6 is a schematic circuit diagram of a modified partial resonance converter 20 having a clamped output according to the invention. The converter 20 comprises an input AC source Vₗᵢₙₑ that is filtered by an RFI filter 21 and rectified by a bridge rectifier 22 to form a source of high voltage DC that is coupled across a pair of anti-phase fast acting bipolar switches S₁ and S₂ that chop the DC voltage to produce quasi-AC in known manner. Respective transorbs T₁ and T₂ are connected across the switches in order that each switch is turned on when its anti-parallel transorb conducts. The transorbs T₁ and T₂ are similar to the diodes shown in FIG. 2 but clamp the voltage and protects against spikes. The transorbs have an intrinsic capacitance that operates in conjunction with an inductor Lr connected at one end to the common junction between the transorbs T₁ and T₂ to soften the switches and reduce power dissipation across the switches. The same effect can be realized by connecting a snubber capacitor across the diodes shown in FIG. 2.

The resulting voltage pulses are stepped-down by a transformer TR, so as to produce at a secondary thereof low voltage AC that is rectified by a pair of FET transistors F₁ and F₂ driven by a FET driver prior to feeding a low voltage DC load. Respective resonant capacitors Cᵣ₁ and Cᵣ₂ are connected across the switches and operate as dc-link capacitors which serve as a voltage divider for the half-bridge inverter. The transformer TR has a primary winding (Lp) that is coupled via a current transformer CT in series with the inductor Lr to the common junction between the transorbs T₁ and T₂. The transformer TR has an auto-secondary winding comprising a pair of windings (Lsec) each having a first end connected at a common junction and a respective second end connected to the drain terminals of the respective FETs F₁ and F₂. A secondary of the current transformer CT is coupled to the FET driver, which is responsive to zero current flowing through the primary winding (Lp) for switching the FETs F₁ and F₂. The source terminals of the FETs F₁ and F₂ are commonly connected to the negative voltage supply terminal of the load to the load via an LC filter comprising Lf and Cf, the positive voltage supply terminal being derived from the mid-point of the voltage transformer secondary winding.

The resonance frequency is defined by the resonant capacitors Cᵣ₁ and Cᵣ₂ in conjunction with the leakage inductance Lₛ of the transformer TR. Clamping diodes D₁ and D₂ are connected across the resonant capacitors Cᵣ₁ and Cᵣ₂ and serve to clamp the output voltage of the series resonance converter by preventing the build up of negative voltage across the resonant capacitors.

The current drive transformer generates high frequency current pulses that are in phase with the high current primary and serve to feed low voltage gate signals to the respective FETs in anti-phase via the respective auto-secondary windings of the step down voltage transformer TR. The voltage transformer operates as a self-oscillator whose output is substantially sinusoidal and reduces switch losses.

The diodes D₁ and D₂ serve to clamp the output voltage of the series resonance converter by preventing the build up of negative voltage across the resonant capacitors Cᵣ₁ and Cᵣ₂. As a result the output voltage of the series resonance converter can never go higher than the network voltage and the maximum power is limited to:

$$P \approx \frac{{CV}_{in}^{2}}{2 T}$$

where T is the resonance period.

FIG. 7 shows schematically a lamp illumination system 30 comprising a track having a pair of DC supply rails 31a and 31b to which are connected multiple lamps 32 constituting a load. The DC supply rails 31a and 31b are fed by two spatially distributed power supplies 20 as shown in FIG. 6. In order to accommodate further lamps 32, additional power supplies 20 may be connected along the track, if required. It will be understood that the invention is equally applicable to any arrangement where lamps are connected across a pair of supply rails or conductors.

Having described the circuit topology, we will now explain its operation. When operating at low power, the voltage at the junction of the capacitors Cᵣ₁ and Cᵣ₂ will be equal to half the supply voltage. If we work at full power, the voltage across each output capacitor is equal to the peak supply voltage. As a result if we now connect say two power supplies in parallel across the DC supply rails 31a and 31b as shown in FIG. 7 and connect a load constituted for example by multiple HID lamps 32 that can be fed by one power supply, then the one power supply can operate in normal mode as though the other power supply is on standby. But if we now increase the number of lamps beyond the maximum power capability of the operational power supply, the other power supply will provide the shortfall.

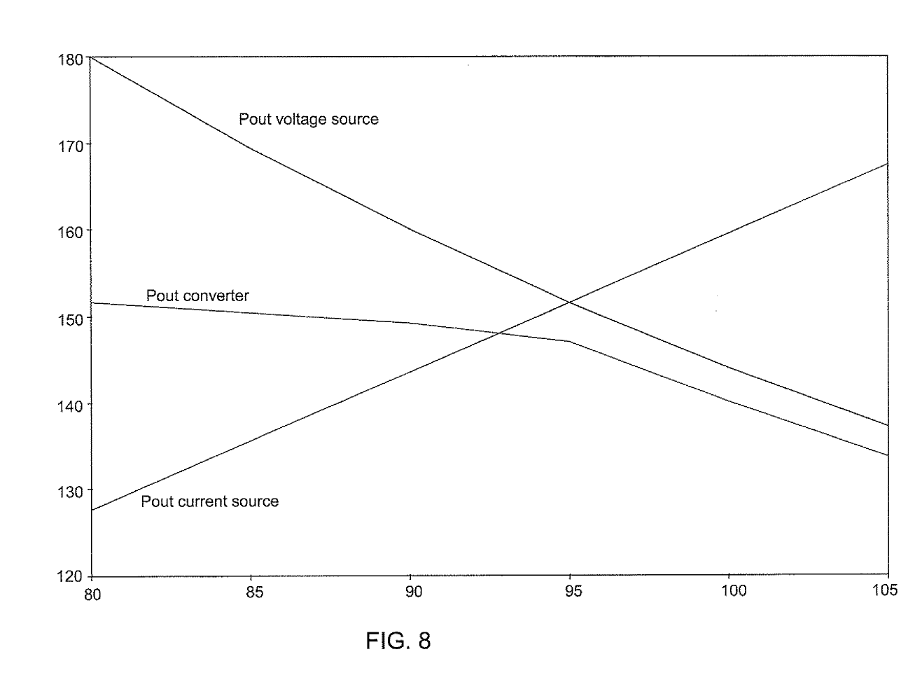

FIG. 8 shows graphically power output-load characteristics of a current source, voltage source and the converter shown in FIG. 6. It may easily be shown that when effective resistance is reduced below nominal value, the converter functions as a constant power supply.

It is seen from FIG. 8, that the converter 20 has an output power limit provided by the clamping diodes D₁ and D₂ which limit voltage across the resonance capacitors Cᵣ₁ and Cᵣ₂.

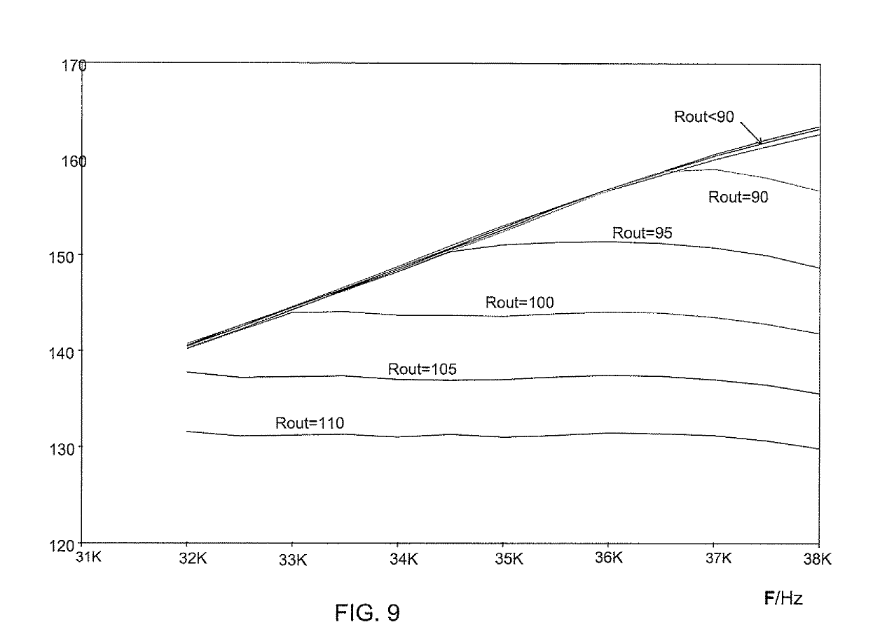

FIG. 9 shows graphically power limit-frequency characteristics of the converter shown in FIG. 6. It is seen that for R<95 Ohm (nominal load) and resonance frequency 35 kHz, the output power is constant=150 W (constant power mode) and on the contrary for R>150 Ohm output power decreases like V out constant.

In order to understand operation of the system, consider a first situation where in FIG. 7 each of the power supplies is rated at 150 W and the total load is only 200 W. In this case, it has been found that a first one of the power supplies will be clamped to the nominal rating of 150 W+15%, i.e. 172.5 W, the remainder or shortfall of 28.5 W being provided by the second power supply, whose output is therefore not clamped. On the other hand, if the load is increased to 300 W, e.g. by the addition of more lamps, then the first power supply will again be clamped to 172.5 W, and the second power supply which again will not be clamped will provide the shortfall of 128.5 W. However, both power supplies must be operable in clamping mode (even though only one is actually operated in clamping mode) so as to limit the output voltage across its resonance capacitors and thereby prevent the power supply from attempting to source a load that exceeds a nominal power rating of the first DC power supply within a predetermined accuracy.

In practice, the accuracy is a function of the tolerance of the circuit components.

The applicant has found that two power supplies having components of 5% tolerance and operating at within 5% of the resonance frequency, will achieve full load distribution by one of the power supplies providing half the full load power+15% and the other will provide the shortfall equal to half the full load power−15%. Between 50% and full power, one unit takes full power+15% and second unit only takes the rest. Below 50% only one power supply is needed.

If the load is more than doubled, then additional power supplies will need to be connected to the supply rails and all but one will typically operate in clamped mode, any shortfall being taken up by the remaining power supply, which will not be clamped.

1. A method for sharing power to an electrical DC load that exceeds a capacity of a first DC power supply between the first DC power supply and a second DC power supply such that in combination all of the power supplies are able to provide rated load power, said method comprising:
(a) connecting across the load the first and second DC power supplies each having a respective partial series resonance converter that produces during alternate switching cycles an output voltage across respective resonance capacitors thereof and each converter being operable in clamping mode; and
(b) operating the converter of the first DC power supply in clamping mode so as to limit an output voltage across the respective resonance capacitors thereof and thereby prevent the first DC power supply from attempting to source a load that exceeds a nominal power rating of the first DC power supply within a predetermined accuracy, whereby any power shortfall to the load is provided by the second DC power supply.

2. A lamp illumination system comprising:
a pair of DC supply rails configured for connecting multiple lamps thereto; and
at least two spatially distributed power supplies connected to the DC supply rails, each of the power supplies comprising a partial resonance converter being operable in clamping mode so as to prevent the respective power supply from attempting to source a load that exceeds a nominal power rating of the power supply within a predetermined accuracy.

3. The lamp illumination system according to claim 2, wherein the partial series resonance converter comprises:
a source of high voltage DC that is coupled across a pair of anti-phase fast acting switches,
respective power dissipation devices connected across the switches for reducing turn-off loss of the respective switches,
respective resonant capacitors connected across the switches,
respective clamping diodes connected across the capacitors for clamping an output voltage of the series resonance converter,
an inductor connected at one end to a common junction between the power dissipation devices,
a step-down transformer having a primary winding and an auto-secondary winding comprising a pair of windings, and
a rectifier connected across the secondary winding of the transformer for feeding low voltage DC to the DC supply rails.

4. The lamp illumination system according to claim 3, wherein the rectifier comprises a pair of FETs having respective drain terminals connected across the secondary winding of the transformer and whose source terminals are commonly connected to form a negative DC supply rail, there being further provided:
a current transformer coupled at a first end in series with the inductor to the common junction between the power dissipation devices and connected at an opposite end to said primary winding, and
a FET driver responsively coupled to the current transformer for switching the FETs.

5. The lamp illumination system according to claim 3, wherein the source of high voltage DC comprises an input AC source that is filtered by an RFI filter and rectified by a rectifier.

6. The lamp illumination system according to claim 3, wherein the power dissipation devices include transorbs.

7. The lamp illumination system according to claim 5, wherein each of the power dissipation devices includes a snubber capacitor connected across a respective diode of said rectifier.

8. The lamp illumination system according to claim 2, wherein the supply rails form part of a track lighting system.
